(19) United States
(12) Patent Application Publication
(10) Pub. No.: US 2017/0248808 A1
(43) Pub. Date: Aug. 31, 2017

(54) DISPLAY DEVICE

(71) Applicant: Young Lighting Technology Inc., Hsin-Chu (TW)

(72) Inventor: HSIUNG-CHUN HSU, Hsin-Chu (TW)

(21) Appl. No.: 15/428,596

(22) Filed: Feb. 9, 2017

(30) Foreign Application Priority Data
Feb. 26, 2016 (TW) 105105770

(51) Int. Cl. G02F 1/1335; F21V 8/00; G02F 1/1333

(52) U.S. Cl. CPC G02F 1/1335; G02F 1/13338; G02F 1/133553; G02B 6/0088; G02F 1/133512

(57) ABSTRACT

A display device includes a display module and a glue body. The display module includes a reflector, a light guide plate, at least one optical film and a display panel sequentially stacked from bottom to top. The reflector, the light guide plate, the at least one optical film and the display panel each have a side surface on the same side of the display device. The glue body is disposed to cover the side surfaces of the reflector, the light guide plate, the at least one optical film and the display panel. The glue body is configured to fix the reflector, the light guide plate, the at least one optical film and the display panel to each other.

### CROSS-REFERENCE TO RELATED APPLICATION

This application claims the priority benefit of Taiwan application serial no. 105105770, filed on Feb. 26, 2016. The entirety of the above-mentioned patent application is hereby incorporated by reference herein and made a part of this specification.

### FIELD OF THE INVENTION

The invention relates to a display device, and more particularly to a display device having less complicated structure.

### BACKGROUND OF THE INVENTION

With the technology development in recent years, handheld electronic products such as smart phones and tablet PCs become more and more popular. Generally, handheld electronic products use liquid crystal display (LCD) screen as a display device.

The liquid crystal display screen includes a display panel and a backlight module disposed on the back (or the bottom) of the display panel. The backlight module includes some components such as a light guide plate, a light emitting unit, an optical film, a back plate and a frame. The light beams provided by the light emitting unit are first uniformly mixed by the light guide plate and then transmitted to the back (or bottom) of the display panel, thereby by functioning as a light source of the display panel.

However, in the conventional structural design of a liquid crystal display screen, the backlight module relies on the back plate and the frame as a base to assembly the components such as the light guide plate, the light emitting unit and the optical film. Thus, the conventional display device may not only require a longer assembly time but also have a much complicated structure. Further, most of the assemblies between the related components of the backlight module are realized by engage means or adhesive. However, this assembly manner is quite time consuming and may lead to high risk of falling component or poor accuracy of assembly alignment when at the case of mass production. Therefore, it is quite important to develop a structure of display device to overcome the aforementioned situation.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

One objective of the invention is to provide a display device with slim and less complicated structure.

In order to achieve one or a portion of or all of the objects or other objects, an embodiment of the invention provides a display device, which includes a display module and a glue body. The display module includes a reflector, a light guide plate, at least one optical film and a display panel sequentially stacked from bottom to top. The reflector, the light guide plate, the at least one optical film and the display panel each have a side surface on the same side of the display device. The glue body is disposed to cover the side surfaces of the reflector, the light guide plate, the at least one optical film and the display panel. The glue body is configured to fix the reflector, the light guide plate, the at least one optical film and the display panel to each other.

In summary, by omitting some conventional components (such as the frame and the back plate) and fixing the existing structural components (such as the reflector, the light guide plate, the optical film and the display panel) to each other through coating glue body on the side surface(s) thereof, the display device of the embodiments of the invention may achieve slim and less complicated structure. Because of having less complicated structure, the display device of the embodiments of the invention accordingly has less complicated assembly process, flexible design, slim frame and higher screen share.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional schematic view of a display device in accordance with an embodiment of the invention;

FIG. 2 is a cross-sectional schematic view of a display device in accordance with another embodiment of the invention;

FIG. 3 is a cross-sectional schematic view of a display device in accordance with another embodiment of the invention;

FIG. 4 is a cross-sectional schematic view of a display device in accordance with another embodiment of the invention;

FIG. 5 is a cross-sectional schematic view of a display device in accordance with another embodiment of the invention;

FIG. 6 is a cross-sectional schematic view of a display device in accordance with another embodiment of the invention;

FIG. 7 is a cross-sectional schematic view of a display device in accordance with another embodiment of the invention;

FIG. 8 is a cross-sectional schematic view of a display device in accordance with another embodiment of the invention;

FIG. 9 is a cross-sectional schematic view of a display device in accordance with another embodiment of the invention; and

FIG. 10 is a cross-sectional schematic view of a display device in accordance with another embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

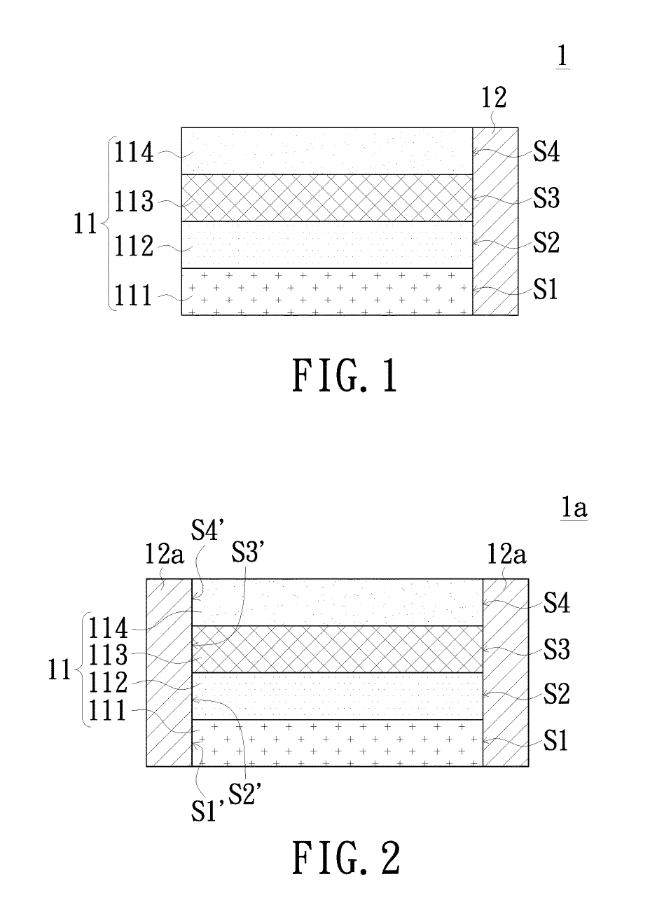

Referring to FIG. 1, which is a cross-sectional schematic view of a display device in accordance with an embodiment of the invention. As shown in FIG. 1, the display device 1 of the embodiment includes a display module 11 and a glue body 12. The display module 11 includes a reflector 111, a light guide plate 112, at least one optical film 113 and a display panel 114 which are sequentially stacked from bottom to top. The reflector 111, the light guide plate 112, the at least one optical film 113 and the display panel 114 have side surfaces S1, S2, S3 and S4 which are on the same side of the display device 1, respectively. The glue body 12 is disposed on one side of display module 11 to cover the side surfaces S1, S2, S3, S4, and thereby fixing the reflector 111, the light guide plate 112, the at least one optical film 113 and the display panel 114 to each other.

It is to be noted that the display module 11 of the embodiment further includes a light source (not shown). The light source is configured to provide light beams to the light guide plate 112. The light beams are mixed by the light guide plate 112 and then transmitted to the display panel 114. However, because of the light source is a minor component in the invention, therefore, the light source is not shown in FIG. 1. Namely, the configuration and arrangement position of the light source are well known in the art and not limited in the invention, and no redundant detail is to be given herein.

In the embodiment, the optical film 113 may be, for example, a light collection sheet, a diffusion sheet, a uniform film, a composite optical film, etc. In addition, the number of the optical film 113 may be two or more than two; and correspondingly, the two or more optical films 113 may be a combination of a light collection sheet, a diffusion sheet, a uniform film and a composite optical film, but the invention is not limited thereto. In the embodiment, the glue body 12 may be a curing glue body with light shielding function. That is, the curing glue body may be added with black ink or dark dye, so as to be provided with the light shielding function. The curing glue body with the light shielding function is to prevent the light beams from being exposed outside the display module 11 during the transmission process of the light beams. In the embodiment, the curing glue body may be a light curing glue body, a thermo curing glue body, etc., but the invention is not limited thereto.

Therefore, for achieving slim and less complicated structure, the structural components such as the reflector 111, the light guide plate 112, the at least one optical film 113 and the display panel 114 are supported by the glue body 12 in the display device 1 of the embodiment, instead of using the frame and the back plate in the conventional display device structure. Moreover, by coating the glue body on one side of the display device 1 in the embodiment, not only the components can be fixed with each other but also the display device 1 can have slim frame and higher screen share. Furthermore, increased thickness and poor accuracy of assembly alignment resulted by the conventional adhesive means in the prior art are solved.

Referring to FIG. 2, which is a cross-sectional schematic view of a display device in accordance with another embodiment of the invention. As shown, the display device 1a of the embodiment of FIG. 2 is similar to the display device 1 of FIG. 1. A difference lies in that the glue body 12a in the display device 1a of the embodiment may be disposed on two opposite sides of the display module 11. Namely, the glue body 12a is disposed to cover the side surfaces S1, S2, S3, S4 as well as the opposite side surfaces S1′, S2′, S3′, S4′ of the reflector 111, the light guide plate 112, the at least one optical film 113, the display panel 114, respectively, thereby enhancing the assembling strengths of the reflector 111, the light guide plate 112, the at least one optical film 113 and the display panel 114 in the embodiment. In another embodiment, it is understood that the glue body may be disposed on any three side surfaces of the display module 11 or disposed to cover all the side surfaces of the display module 11 in response to actual requirements.

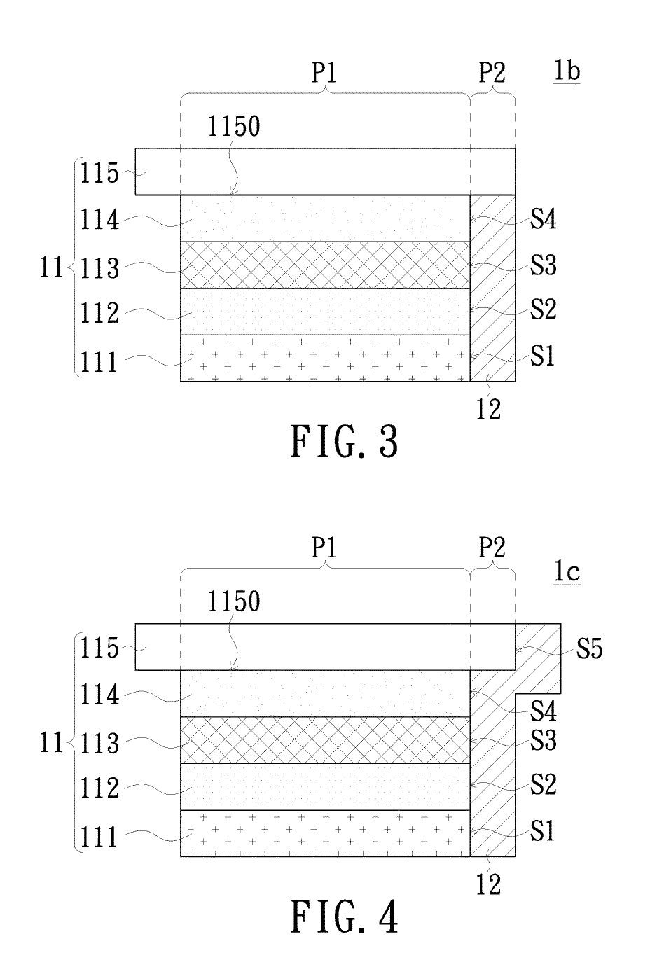

Referring to FIG. 3, which is a cross-sectional schematic view of a display device in accordance with another embodiment of the invention. As shown, the display device lb of the embodiment of FIG. 3 is similar to the display device 1 of FIG. 1. A difference lies in that the display device 1b of the embodiment further includes a touch panel 115; namely, the display device 1b of the embodiment may be is a touch display device. In the embodiment, the touch panel 115 is disposed to stack on the display panel 114. The touch panel 115 has a surface 1150 which faces the display panel 114. The surface 1150 has a first portion P1 overlapping the display panel 114 and a second portion P2 exposed from the display panel 114. The glue body 12 is disposed to cover the side surface S1 of the reflector 111, the side surface S2 of the light guide plate 112, the side surface S3 of the at least one optical film 113, the side surface S4 of the display panel 114 and the second portion P2 of the surface 1150 of the touch panel 115.

Referring to FIG. 4, which is a cross-sectional schematic view of a display device in accordance with another embodiment of the invention. As shown, the display device 1c of the embodiment of FIG. 4 is similar to the display device 1b of FIG. 3. A difference lies in that the glue body 12 in the display device 1c of the embodiment may be disposed to cover the side surface S1 of the reflector 111, the side surface S2 of the light guide plate 112, the side surface S3 of the at least one optical film 113, the side surface S4 of the display panel 114, the second portion P2 of the surface 1150 of the touch panel 115 and a side surface S5 of the touch panel 115. The side surface S5 of the touch panel 115 is on the same side with the side surfaces S1, S2, S3 and S4.

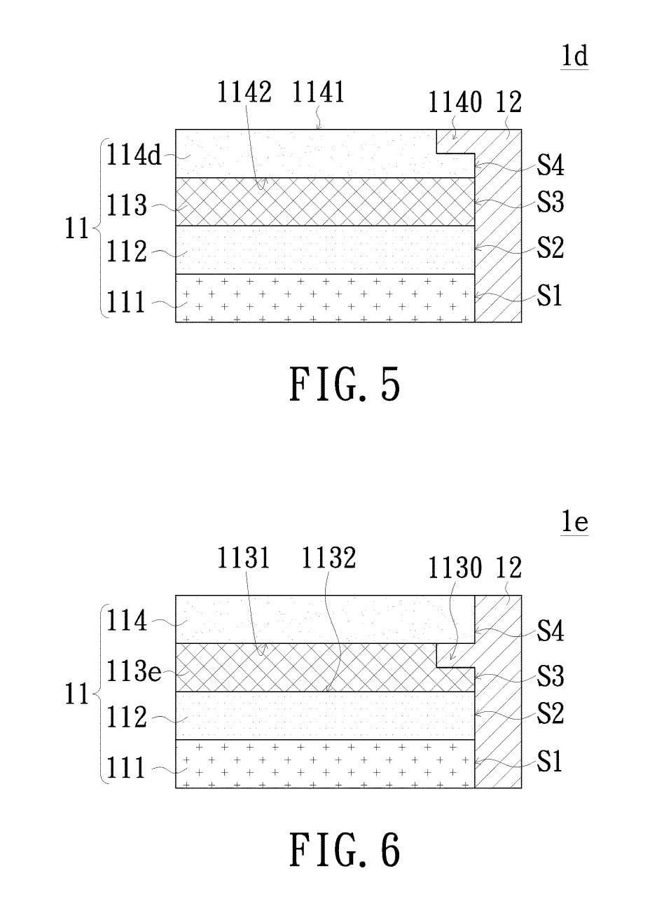

Referring to FIG. 5, which is a cross-sectional schematic view of a display device in accordance with another embodiment of the invention. As shown, the display device 1d of the embodiment of FIG. 5 is similar to the display device 1 of FIG. 1. A difference lies in that the display panel 114d in the display device 1d of the embodiment has a notch structure 1140. Specifically, the display panel 114d has a first surface 1141 and a second surface 1142 which are opposite to each other. The second surface 1142 faces the at least one optical film 113. The notch structure 1140 is provided between the first surface 1141 and the second surface 1142. In addition, the notch structure 1140 is hollow inwardly from the side surface S4 of the display panel 114d; that is, the notch structure 1140 is hollow in a direction toward a side surface opposite to the side surface S4. The glue body 12 is disposed to cover the side surface S1 of the reflector 111, the side surface S2 of the light guide plate 112, the side surface S3 of the at least one optical film 113, the side surface S4 of the display panel 114d and the notch structure 1140 of the display panel 114d.

Referring to FIG. 6, which is a cross-sectional schematic view of a display device in accordance with another embodiment of the invention. As shown, the display device 1e of the embodiment of FIG. 6 is similar to the display device 1 of FIG. 1. A difference lies in that the at least one optical film 113e in the display device 1e of the embodiment has a notch structure 1130. Specifically, the optical film 113e has a first surface 1131 and a second surface 1132 which are opposite to each other. The first surface 1131 faces the display panel 114 and the second surface 1132 faces the light guide plate 112. The notch structure 1130 is provided between the first surface 1131 and the second surface 1132. In addition, the notch structure 1130 is hollow inwardly from the side surface S3 of the optical film 113e; that is, the notch structure 1130 is hollow in a direction toward a side surface opposite to the side surface S3. The glue body 12 is disposed to cover the side surface S1 of the reflector 111, the side surface S2 of the light guide plate 112, the side surface S3 of the at least one optical film 113e, the side surface S4 of the display panel 114 and the notch structure 1130 of the optical film 113e.

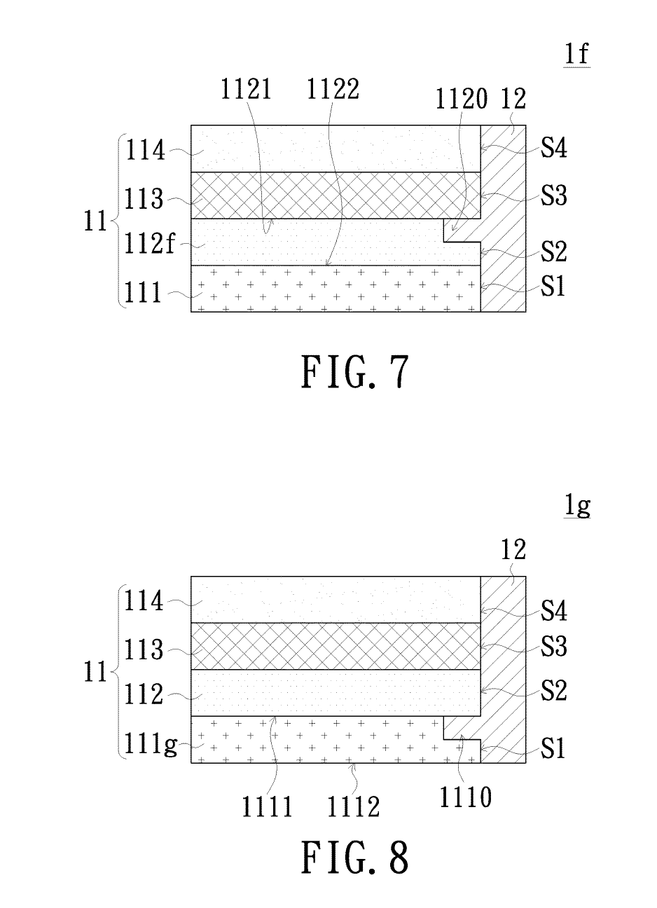

Referring to FIG. 7, which is a cross-sectional schematic view of a display device in accordance with another embodiment of the invention. As shown, the display device if of the embodiment of FIG. 7 is similar to the display device 1 of FIG. 1. A difference lies in that the light guide plate 112f in the display device 1f of the embodiment has a notch structure 1120. Specifically, the light guide plate 112f has a first surface 1121 and a second surface 1122 which are opposite to each other. The first surface 1121 faces the at least one optical film 113 and the second surface 1122 faces the reflector 111. The notch structure 1120 is provided between the first surface 1121 and the second surface 1122. In addition, the notch structure 1120 is hollow inwardly from the side surface S2 of the light guide plate 112f; that is, the notch structure 1120 is hollow in a direction toward a side surface opposite to the side surface S2. The glue body 12 is disposed to cover the side surface S1 of the reflector 111, the side surface S2 of the light guide plate 112f, the side surface S3 of the at least one optical film 113, the side surface S4 of the display panel 114 and the notch structure 1120 of the light guide plate 112f.

Referring to FIG. 8, which is a cross-sectional schematic view of a display device in accordance with another embodiment of the invention. As shown, the display device 1g of the embodiment of FIG. 8 is similar to the display device 1 of FIG. 1. A difference lies in that the reflector 111g in the display device 1g of the embodiment has a notch structure 1110. Specifically, the reflector 111g has a first surface 1111 and a second surface 1112 which are opposite to each other. The first surface 1111 faces the light guide plate 112. The notch structure 1110 is provided between the first surface 1111 and the second surface 1112. In addition, the notch structure 1110 is hollow inwardly from the side surface S1 of the reflector 111g; that is, the notch structure 1110 is hollow in a direction toward a side surface opposite to the side surface S1. The glue body 12 is disposed to cover the side surface S1 of the reflector 111g, the side surface S2 of the light guide plate 112, the side surface S3 of the at least one optical film 113, the side surface S4 of the display panel 114 and the notch structure 1110 of the reflector 111g.

During the coating process, the glue body 12 may permeate to the visible area of the display device through the gaps between the components due to the capillarity, thereby causing the display device to generate an abnormal displaying. Therefore, the notch structure 1140, 1130, 1120, 1110 of the display panel 114d, the optical film 113e, the light guide plate 112f, the reflector 111 in the display device 1d, 1e, 1f, 1g may prevent the glue body 12 from permeating into the gaps between the aforementioned components, respectively. In detail, because of the space of the notch structure 1140, 1130, 1120, 1110 is much larger than the gaps between the components, the glue body 12 will flow into the notch structures 1140, 1130, 1120, 1110 first rather than the gaps between the components during the coating process. Meanwhile, because of the glue body 12 flows into the notch structure, the bonding area is increased and consequentially the assembling strengths of the reflector 111, the light guide plate 112, the optical film 113 and the display panel 114 are enhanced. Further, in the display device 1d, 1e, 1f, 1g of FIG. 5 to FIG. 8, the display panel 114d, the optical film 113e, the light guide plate 112f, the reflector 111g each are illustrated by having one notch structure 1140, 1130, 1120 and 1110 only, respectively. However, it is understood that the number of the notch structure is not limited in the invention; that is, more than one notch structure may be provide in response to actual requirements.

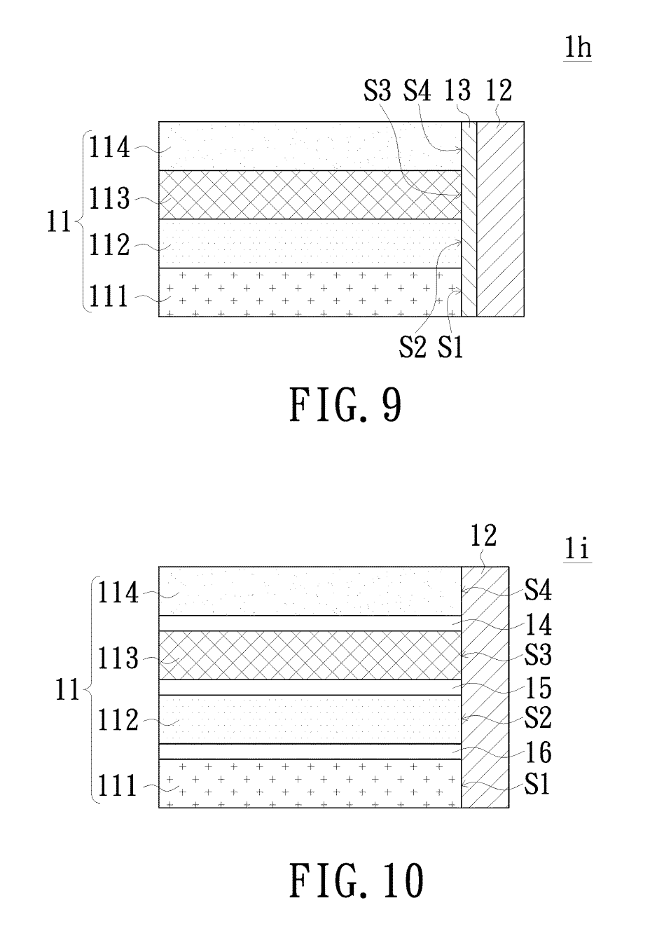

Referring to FIG. 9, which is a cross-sectional schematic view of a display device in accordance with another embodiment of the invention. As shown, the display device 1h of the embodiment of FIG. 9 is similar to the display device 1 of FIG. 1. A difference lies in that the display device 1h of the embodiment further includes a waterproof insulating glue body 13. The waterproof insulating glue body 13 is disposed between the glue body 12 and the side surfaces S1, S2, S3, S4 of the reflector 111, the light guide plate 112, the at least one optical film 113, the display panel 114, respectively. In the embodiment, the waterproof insulating glue body 13 is configured to prevent the glue body 12 from permeating into the gaps between the aforementioned components.

Referring to FIG. 10, which is a cross-sectional schematic view of a display device in accordance with another embodiment of the invention. As shown, the display device 1i of the embodiment of FIG. 10 is similar to the display device 1 of FIG. 1. A difference lies in that the display device 1i of the embodiment further includes a first glue layer 14, a second glue layer 15 and a third glue layer 16. The first glue layer 14 is disposed between the display panel 114 and the at least one optical film 113. The second glue layer 15 is disposed between the at least one optical film 113 and the light guide plate 112. The third glue layer 16 is disposed between the light guide plate 112 and the reflector 111. In the embodiment, the first glue layer 14, the second glue layer 15 and the third glue layer 16 may be solid optical transparent glue or liquid optical transparent glue, but the invention is not limited thereto. The first glue layer 14, the second glue layer 15 and the third glue layer 16 between the aforementioned components may prevent the glue body 12 from permeating into the gaps between the aforementioned components.

It is to be noted that through the structures provided by FIG. 5 to FIG. 10, the glue body 12 may be prevented from permeating into the gaps between the related components. In another embodiment, the glue body 12 may be prevented from permeating into the gaps between the related components through performing an compression on the stacked structure formed by the reflector 111, the light guide plate 112, the at least one optical film 113 and the display panel 114.

In addition, it is to be noted that the glue body in the display devices of the embodiments of FIG. 3 to FIG. 10 may be disposed to cover the two opposite side surfaces, any three side surfaces or all the side surfaces of the respective display modules, same as shown in the display device of FIG. 2.

In summary, the display devices of the embodiments of the invention have at least one of the following advantages. By omitting some conventional components (such as the frame and the back plate) and fixing the existing structural components (such as the reflector, the light guide plate, the optical film and the display panel) to each other through coating glue body on the side surface(s) thereof, the display device of the embodiments of the invention may achieve slim and less complicated structure. Because of having less complicated structure, the display device of the embodiments of the invention accordingly has less complicated assembly process, flexible design, slim frame and higher screen share.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first stop part, the second stop part, the first ring part and the second ring part are only used for distinguishing various elements and do not limit the number of the elements.

What is claimed is:

1. A display device, comprising:
a display module, comprising a reflector, a light guide plate, at least one optical film and a display panel sequentially stacked from bottom to top, wherein the reflector, the light guide plate, the at least one optical film and the display panel each have a side surface on the same side of the display device; and
a glue body, disposed to cover the side surfaces of the reflector, the light guide plate, the at least one optical film and the display panel, wherein the glue body is configured to fix the reflector, the light guide plate, the at least one optical film and the display panel to each other.

2. The display device according to claim 1, wherein the display module further comprises a touch panel disposed to stack on the display panel, the touch panel has a surface facing the display panel, the surface has a first portion overlapping the display panel and a second portion exposed from the display panel, and the glue body is disposed to cover the second portion of the surface.

3. The display device according to claim 2, wherein the touch panel has a side surface on the side of the display device, and the glue body is disposed to cover the side surface of the touch panel.

4. The display device according to claim 1, wherein the display panel has a first surface, a second surface and a notch structure, the first surface and the second surface are opposite to each other, the notch structure is provided between the first surface and the second surface, the second surface faces the at least one optical film, the notch structure is hollow inwardly from the side surface of the display panel, and the glue body is disposed to cover the notch structure.

5. The display device according to claim 1, wherein the at least one optical film has a first surface, a second surface and a notch structure, the first surface and the second surface are opposite to each other, the notch structure is provided between the first surface and the second surface, the first surface faces the display panel and the second surface faces the light guide plate, the notch structure is hollow inwardly from the side surface of the at least one optical film, and the glue body is disposed to cover the notch structure.

6. The display device according to claim 1, wherein the light guide plate has a first surface, a second surface and a notch structure, the first surface and the second surface are opposite to each other, the notch structure is provided between the first surface and the second surface, the first surface faces the at least one optical film and the second surface the reflector, the notch structure is hollow inwardly from the side surface of the light guide plate, and the glue body is disposed to cover the notch structure.

7. The display device according to claim 1, wherein the reflector has a first surface, a second surface and a notch structure, the first surface and the second surface are opposite to each other, the notch structure is provided between the first surface and the second surface, the first surface faces the light guide plate, the notch structure is hollow inwardly from the side surface of the reflector, and the glue body is disposed to cover the notch structure.

8. The display device according to claim 1, further comprising a waterproof insulating glue body disposed between the glue body and the side surfaces of the reflector, the light guide plate, the at least one optical film and the display panel.

9. The display device according to claim 1, further comprising:
a first glue layer, disposed between the display panel and the at least one optical film;
a second glue layer, disposed between the at least one optical film and the light guide plate; and
a third glue layer, disposed between the light guide plate and the reflector.

10. The display device system according to claim 1, wherein the glue body is a curing glue body with light shielding function.
